(19) United States
(12) Patent Application Publication
(10) Pub. No.: US 2025/0316744 A1
(43) Pub. Date: Oct. 9, 2025

(54) SECONDARY BATTERY MANUFACTURING DEVICE AND BATTERY MODULE INCLUDING SECONDARY BATTERY MANUFACTURED BY SECONDARY BATTERY MANUFACTURING DEVICE

(71) Applicant: SAMSUNG SDI CO., LTD., Yongin-si (KR)

(72) Inventors: Hyun Ki JUNG, Yongin-si (KR); Mun Sung KIM, Yongin-si (KR); Jung Hyun PARK, Yongin-si (KR); Ji Sang RYU, Yongin-si (KR); Myung Seob KIM, Yongin-si (KR); Gwan Hyeon YU, Yongin-si (KR); Woo Tae JUN, Yongin-si (KR); Yoon Sun YOO, Yongin-si (KR)

(21) Appl. No.: 19/026,825

(22) Filed: Jan. 17, 2025

(30) Foreign Application Priority Data
Apr. 8, 2024 (KR) 10-2024-0047103

(51) Int. Cl. H01M 10/04

(52) U.S. Cl. CPC H01M 10/0431

(57) ABSTRACT

A secondary battery manufacturing device according to an embodiment of the present disclosure may include an unwinder configured to supply a wound electrode plate foil and a plurality of slitters configured to cut the electrode plate foil supplied from the unwinder at predetermined intervals to form a plurality of electrode plate foils. The device may further include a plurality of rewinders configured to wind the electrode plate foils discharged from the slitters in one direction, and a first winding device and a second winding device configured to wind the electrode plate foils discharged from the separators and separators and discharge the wound electrode assemblies that include the electrode plate foils and separators. With the device, a process of unwinding and rewinding a previously wound winding material to adjust a direction of an uncoated portion or electrode plate surface is not necessary, and the manufacturing time for a secondary battery may be reduced.

### CROSS-REFERENCE TO RELATED APPLICATION

This application claims priority to and the benefit of Korean Patent Application No. 10-2024-0047103 filed on Apr. 8, 2024, in the Korean Intellectual Property Office, the contents of which in its entirety are herein incorporated by reference.

### BACKGROUND

### 1. Field

An embodiment of the present disclosure relates to a secondary battery manufacturing device and a battery module including a secondary battery manufactured by the secondary battery manufacturing device.

### 2. Description of the Related Art

A secondary battery can be charged and discharged, unlike a primary battery which cannot be re-charged. Low-capacity secondary batteries are used in small portable electronic devices such as smartphones, feature phones, laptop computers, digital cameras, camcorders, and the like. Large-capacity secondary batteries are widely used as motor driving power sources and power storage batteries in hybrid vehicles, electric vehicles, and the like. Secondary batteries include an electrode assembly composed of a positive electrode and a negative electrode, a case which accommodates the electrode assembly, and an electrode terminal connected to the electrode assembly.

The above-described information is disclosed as background technology of the present disclosure and is only for improving understanding of the background of the present disclosure, and therefore may include information that does not constitute the related art.

### SUMMARY

An embodiment of the present disclosure is directed to providing a secondary battery manufacturing device with an improved winding structure and a battery module including a secondary battery manufactured by the secondary battery manufacturing device.

However, the technical problems to be solved by the present disclosure are not limited to the above-described technical problems, and other technical problems that are not mentioned herein will be clearly understood by those skilled in the art from the following description.

A secondary battery manufacturing device according to an embodiment of the present disclosure may include: an unwinder configured to supply a wound electrode plate foil; a plurality of slitters configured to cut the electrode plate foil supplied from the unwinder at predetermined intervals to form a plurality of electrode plate foils; a plurality of rewinders configured to wind the electrode plate foils discharged from the slitters in one direction; and a first winding device and a second winding device configured to wind the electrode plate foils discharged from the rewinders and separators wound and to discharge wound electrode assemblies that include the electrode plate foils and separators.

The electrode plate foils may include portions coated with an active material and uncoated portion that are not coated with an active material, and the uncoated portions of reels of the wound electrode plate foils discharged from the rewinders may face different directions.

The reels of the wound electrode plate foils discharged from the rewinders may have a same type of surface facing the outside of winding.

The unwinder is provided as two unwinders, with a first of the unwinders being configured to supply a negative electrode plate foil and a second of the unwinders being configured to supply a positive electrode plate foil.

The first winding device may wind the electrode assembly such that a negative electrode uncoated portion and a positive electrode uncoated portion face different directions direction.

The second winding device may wind the electrode assembly such that a negative electrode uncoated portion and a positive electrode uncoated portion face directions opposite to the directions that the negative electrode uncoated portion and the positive electrode uncoated portion face in the electrode assembly wound by the first winding device.

The first winding device and the second winding device are configured to wind electrode assemblies in different directions.

The negative electrode plate foil and the positive electrode plate foil may be coated with an active material in a stripe pattern along a longitudinal direction.

Any one of the negative electrode plate foil and the positive electrode plate foil or both the negative electrode plate foil and the positive electrode plate foil may be coated with the active material on one surface or both surfaces thereof in an unbalanced manner.

Further, a battery module according to the embodiment of the present disclosure may include a plurality of secondary batteries manufactured by the above-described secondary battery manufacturing device.

The secondary batteries may include a plurality of first secondary batteries and second secondary batteries in which electrode assemblies are wound in opposite directions.

Each of the electrode assemblies may include a negative electrode plate and a positive electrode plate.

Each of the negative electrode plates and the positive electrode plates may be coated with an active material in a stripe pattern along a longitudinal direction.

Any one of the negative electrode plate and the positive electrode plate or both the negative electrode plate and the positive electrode plate may be coated with an active material on one surface or both surfaces thereof in an unbalanced manner.

### BRIEF DESCRIPTION OF DRAWINGS

The drawings of the present disclosure exemplify preferred embodiments of the present disclosure, and serve to help further understanding of the technical spirit of the present disclosure together with the following detailed description of the present disclosure, but the present disclosure is not limited to the items disclosed in the drawings:

FIG. 1 is a perspective view of an exemplary cylindrical secondary battery;

FIG. 2 is a cross-sectional view of the cylindrical secondary battery according to FIG. 1;

FIG. 3 is a perspective view of an exemplary cylindrical secondary battery;

FIG. 4 is a cross-sectional view of the cylindrical secondary battery according to FIG. 3;

FIG. 5 is a schematic diagram briefly illustrating a winding material supply state during winding of an exemplary electrode assembly;

FIG. 6 is a schematic diagram illustrating a part of a winding process of an electrode assembly according to one embodiment;

FIG. 7 is a schematic diagram illustrating a part of the winding process of an electrode assembly according to another embodiment;

FIG. 8 is a schematic diagram briefly illustrating a secondary battery manufacturing device according to the present disclosure;

FIG. 9 is a schematic diagram briefly illustrating an electrode assembly wound by a first winding device according to FIG. 8;

FIG. 10 is a schematic diagram briefly illustrating an electrode assembly wound by a second winding device according to FIG. 8;

FIGS. 11 and 12 are perspective views illustrating a battery pack including an exemplary secondary battery according to the present disclosure; and

FIGS. 13 and 14 are a perspective view and a side view illustrating vehicles including the exemplary battery pack according to the present disclosure.

### DETAILED DESCRIPTION

Hereinafter, the present disclosure will be described in detail with reference to the accompanying drawings. The terms and words used in the present specification and claims should not be construed as being limited to their usual or dictionary meanings, and should be interpreted as meanings and concepts consistent with the proposed technical spirit of the present disclosure based on the principle that the inventor may appropriately define the concept of terms to describe his/her invention in the best way. Accordingly, since the embodiments disclosed in the present specification and configurations shown in the drawings are only some of the most preferable embodiments of the present disclosure and do not represent the entire technical spirit of the present disclosure, it should be understood that there are various equivalents and modifications are possible.

Further, when used in the present disclosure, “comprise or include” and/or “comprising or including” specify the presence of mentioned shapes, numbers, steps, operations, members, elements and/or groups thereof, and do not exclude the presence or addition of one or more other shapes, numbers, steps, operations, members, elements and/or groups thereof.

In addition, in order to help understanding of the disclosure, the accompanying drawings are not drawn to actual scale and the sizes of some components may be exaggerated. In addition, the same reference numerals may be given to the same components in different embodiments.

Stating that two objects for comparison are “the same” means that the two objects are “substantially the same.” Accordingly, “substantially the same” may include a deviation considered to be a low level in the art, for example, a deviation within 5%. Further, uniformity of a parameter in a certain area may mean uniformity from an average perspective.

Although first, second, and the like are used to describe various components, these components are not limited by these terms. These terms are only used to distinguish one component from another component, and a first component may also be a second component unless otherwise stated.

Throughout the specification, unless otherwise stated, each component may be singular or plural.

The disposition of an arbitrary component at “an upper portion (or a lower portion)” of a component or “on (or under)” the component means that another component may be interposed between the component and the arbitrary component disposed on (or under) the component or the arbitrary component may be disposed in contact with an upper surface (or a lower surface) of the component.

Further, when it is disclosed that a certain component is “connected,” “coupled,” or “linked” to another component, it should be understood that the components may be directly connected or linked to each other, but another component may be “interposed” between the components, or the components may be “connected,” “coupled,” or “linked” through another component. In addition, a case in which a certain part is electrically connected to another part includes not only a case in which the parts are directly connected, but also a case in which the parts are connected with another element therebetween.

Throughout the specification, “A and/or B” refers to A, B, or A and B unless otherwise stated. That is, “and/or” includes all or any combination of a plurality of listed items. “C to D” means greater than or equal to C and less than or equal to D unless otherwise specified.

The terms used in the present specification are provided for describing the embodiments of the present disclosure, and are not intended to limit the present disclosure.

Hereinafter, a secondary battery manufacturing device according to embodiments of the present disclosure and a battery module including a secondary battery manufactured by the secondary battery manufacturing device will be described in detail with reference to the accompanying drawings.

First, exemplary structures of the secondary battery will be described.

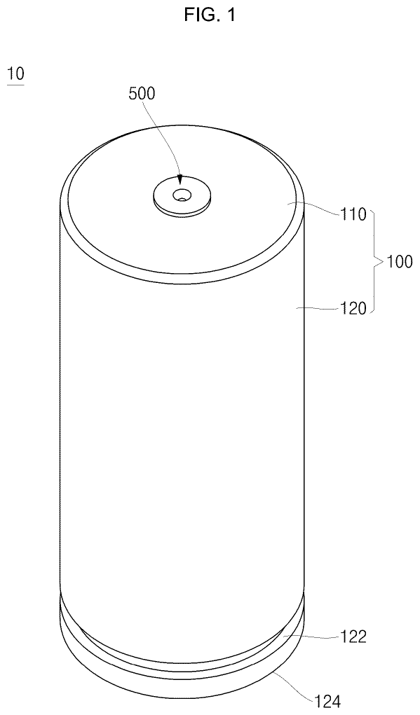

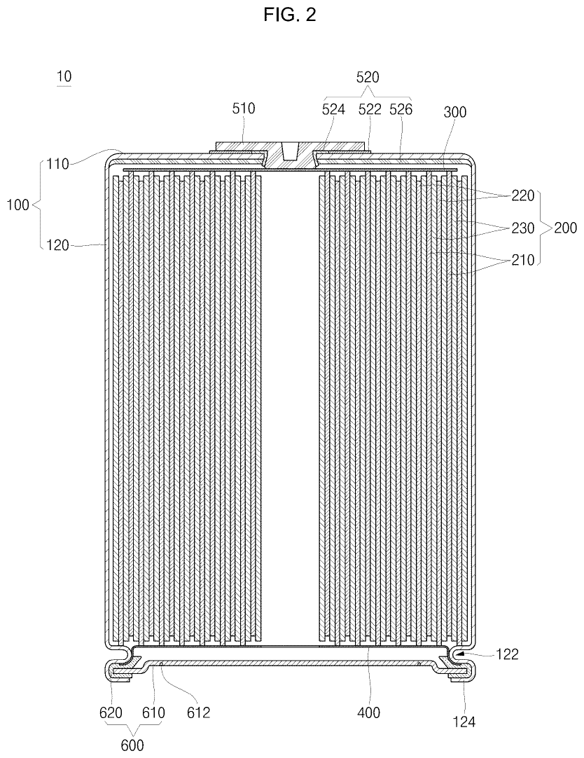

FIG. 1 is a perspective view of an exemplary cylindrical secondary battery. FIG. 2 is a cross-sectional view of the cylindrical secondary battery according to FIG. 1.

Referring to FIGS. 1 and 2, an exemplary secondary battery 10 may include a cylindrical can 100, an electrode assembly 200, a first electrode current collector plate 300 and a second electrode current collector plate 400 accommodated in the can 100, a terminal portion 500 provided at one side of the can 100, and a cap assembly 600 provided at the other side of the can 100.

The can 100 may constitute an exterior of the secondary battery 10 and may have a cylindrical shape having one open end. The can 100 may include or be referred to as a case, a housing, or an exterior material. The can 100 may include a disk-shaped upper surface portion 110 and a cylindrical side portion 120 extending downward from the upper surface portion 110. A terminal hole is formed through the upper surface portion 110, and the terminal portion 500 is provided in the terminal hole. A beading portion 122 may be formed adjacent to an end portion of the side portion 120. The beading portion 122 is formed concavely toward an inner side of the side portion 120. The beading portion 122 is provided so that the electrode assembly 200 is fixed and the cap assembly 600 is seated. A crimping portion 124 is formed at an end portion of the side portion 120 spaced apart from the beading portion 122. The crimping portion 124 may be formed as the end portion of the side portion 120 and is bent toward the inside of the can 100. The cap assembly 600 may be seated and fixed between the beading portion 122 and the crimping portion 124. In a manufacturing process, an open lower end of the can 100 may be disposed to face upward and then the electrode assembly 200 may be inserted along with an electrolyte. Thereafter, the cap assembly 600 may be seated in the beading portion 122 and then the crimping portion 124 may be formed to fix the cap assembly 600 such that the cap assembly 600 may be disposed to face downward again. The cap assembly 600 may also be used in a state of facing upward as necessary. The embodiment is described based on an example in which a lower portion of the can 100 is open, but conversely, the can 100 may also have a form in which an upper portion is open. The can 100 may be made, for example, of steel, nickel-plated steel, a steel alloy, aluminum, an aluminum alloy, metal such as cold rolled steel sheet for deep drawing (SPCE) or the like, or a laminated film or plastic material forming a pouch. The electrode assembly 200 is accommodated in the can 100 along with the electrolyte.

The electrode assembly 200 may include or be referred to as an electrode group, an electrode body, or a jellyroll. The electrode assembly 200 may include a first electrode plate 210, a second electrode plate 220, and a separator 230 interposed between the first electrode plate 210 and the second electrode plate 220. The electrode assembly 200 may be wound in a cylindrical form. The first electrode plate 210 and the second electrode plate 220 are electrically connected to a first electrode current collector plate 300 and a second electrode current collector plate 400, respectively. The first electrode plate 210 may serve as a positive electrode and the second electrode plate 220 may serve as a negative electrode or vice versa. In some examples, a hollow cylindrical core may be provided in a center of the electrode assembly 200. Further, in some examples, a center pin may be inserted in the core.

The first electrode plate 210 may be either a negative electrode plate or a positive electrode plate. The first electrode plate 210 may include a first base material that is a thin metal plate, a first active material layer provided on at least one surface of the first base material, and a first uncoated portion not provided with the first active material. The first uncoated portion may be referred to as the first base material. The first base material may be disposed toward the upper surface portion 110 of the can 100 and electrically connected to the first electrode current collector plate 300.

The first electrode plate 210 may function as a positive electrode. The first base material may include an aluminum foil, and the first active material layer may include a transition metal oxide. The first base material may be referred to as a first metal current collector, a first electrode plate foil, or the like.

In some examples, a compound capable of reversibly intercalating/deintercalating lithium ions (a lithiated intercalation compound) may be used as a positive electrode active material. Specifically, one or more types of composite oxides of a metal selected from cobalt, manganese, nickel, and a combination thereof and lithium may be used. The composite oxide may be a lithium transition metal composite oxide, and a specific example of the composite oxide may be a lithium nickel-based oxide, lithium cobalt-based oxide, lithium manganese-based oxide, lithium iron phosphate-based compound, cobalt-free nickel-manganese-based oxide, or a combination thereof. For example, a compound represented as any of the following chemical formulas such as LiₐA_{1-b}X_{b}O_{2-c}D_{c} (0.90≤a≤1.8, 0≤b≤0.5, 0≤c≤0.05), LiₐMn_{2-b}X_{b}O_{4-c}D_{c} (0.90≤a≤1.8, 0≤b≤0.5, 0≤c≤0.05), LiₐNi_{1-b-c}Co_{b}X_{c}O_{2-α}D_{α} (0.90≤a≤1.8, 0≤b≤0.5, 0≤c≤0.5, 0<α<2), LiₐNi_{1-b-c}Mn_{b}X_{c}O_{2-α}D_{α} (0.90≤a≤1.8, 0≤b≤0.5, 0≤c≤0.5, 0<α<2), LiₐNi_{b}Co_{c}Ll_{d}GₑO₂ (0.90≤a≤1.8, 0≤b≤0.9, 0≤c≤0.5, 0≤d≤0.5, 0≤e≤0.1), LiₐNiG_{b}O₂ (0.90≤a≤1.8, 0.001≤b≤0.1), LiₐCoG_{b}O₂ (0.90≤a≤1.8, 0.001≤b≤0.1), LiₐMn_{1-b}GbO₂ (0.90≤a≤1.8, 0.001≤b≤0.1), LiₐMn₂G_{b}O₄ (0.90≤a≤1.8, 0.001≤b≤0.1), LiₐMn_{1-g}G_{g}PO₄ (0.90≤a≤1.8, 0≤g≤0.5), Li_{(3-f)}Fe₂(PO₄)₃ (0≤f≤2), and LiₐFePO₄ (0.90≤a≤1.8) may be used. In these chemical formulas, A is Ni, Co, Mn, or a combination thereof, X is Al, Ni, Co, Mn, Cr, Fe, Mg, Sr, V, a rare earth element, or a combination thereof, D is O, F, S, P, or a combination thereof, G is Al, Cr, Mn, Fe, Mg, La, Ce, Sr, V, or a combination thereof, and L1 is Mn, Al, or a combination thereof.

A positive electrode for a lithium secondary battery may include a current collector (for example, the first base material) and a positive electrode active material layer formed on the current collector. The positive electrode active material layer may include a positive electrode active material and further include a binder and/or a conductive material.

A content of the positive electrode active material may be in an amount of 90% to 99.5% by weight based on 100% by weight of the positive electrode active material layer. A content of each of the binder and the conductive material may be in an amount of 0.5% to 5% by weight based on 100% by weight of the positive electrode active material layer.

Aluminum may be used as the current collector, but the present disclosure is not limited thereto.

The second electrode plate 220 may be the other of the negative electrode plate and the positive electrode plate. The second electrode plate 220 may include a second base material that is a thin metal plate, a second active material layer provided on at least one surface of the second base material, and a second uncoated portion not provided with the second active material. The second uncoated portion may be disposed toward a lower end of the side portion 120 of the can 100 and electrically connected to the second electrode current collector plate 400.

The second electrode plate 220 may function as a negative electrode. The second base material may include a copper or nickel foil, and the second active material layer may include a carbon-based material, Si, Sn, tin oxide, a tin alloy composite, a transition metal oxide, lithium metal nitrite, a metal oxide, or the like. The second base material may be referred to as a second metal current collector, a second electrode plate foil, or the like.

The negative electrode active material includes a material capable of reversibly intercalating/deintercalating lithium ions, lithium metal, an alloy of lithium metal, a material capable of doping and dedoping lithium, or a transition metal oxide. The material capable of reversibly intercalating/deintercalating lithium ions is a carbon-based negative electrode active material, and may include, for example, crystalline carbon, amorphous carbon, or a combination thereof. An example of the crystalline carbon may be graphite such as natural graphite or artificial graphite, and an example of the amorphous carbon may be soft carbon, hard carbon, mesophase pitch carbide, calcined coke, or the like.

An Si-based negative electrode active material or Sn-based negative electrode active material may be used as the material capable of reversibly intercalating/deintercalating lithium ions. The Si-based negative electrode active material may be silicon, a silicon-carbon composite, SiOₓ (0<x<2), an Si-based alloy, or a combination thereof. The silicon-carbon composite may be a composite of silicon and amorphous carbon. According to one embodiment, the silicon-carbon composite may have a form of silicon particles and amorphous carbon coated on the surface of the silicon particles. The silicon-carbon composite may further include crystalline carbon. For example, the silicon-carbon composite may include a core containing crystalline carbon and silicon particles, and an amorphous carbon coating layer located on the surface of the core.

A negative electrode for a lithium secondary battery may include a current collector (for example, the second base material) and a negative electrode active material layer formed on the current collector. The negative electrode active material layer may include a negative electrode active material and further include a binder and/or a conductive material.

The negative electrode active material layer may include the negative electrode active material in an amount of 90% to 99.5% by weight, the binder in an amount of 0.5% to 5% by weight, and the conductive material in an amount of 0% to 5% by weight.

A non-aqueous binder, an aqueous binder, a dry binder, or a combination thereof may be used as the binder. When an aqueous binder is used as the negative electrode binder, a cellulose-based compound capable of imparting viscosity may be further included.

Any one of a copper foil, a nickel foil, a stainless steel foil, a titanium foil, nickel foam, copper foam, a polymer base material coated with a conductive metal, and a combination thereof may be used as the current collector.

The separator 230 is disposed between the first electrode plate 210 and the second electrode plate 220 to prevent a short circuit and allow lithium ions to move between the plates 210 and 220. The separator may include, for example, a porous base material and a coating layer containing an organic material, an inorganic material, or a combination thereof located on one surface or both surfaces of the porous base material. The organic material may include a polyvinylidene fluoride-based polymer or (meth)acrylic-based polymer. The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto. The organic material and the inorganic material may be present as a mixture in one coating layer or present in a stacked form of a coating layer containing an organic material and a coating layer containing an inorganic material.

The electrolyte for a lithium secondary battery may include a non-aqueous organic solvent and a lithium salt. The non-aqueous organic solvent serves as a medium through which ions involved in an electrochemical reaction of the battery may move. The non-aqueous organic solvent may be a carbonate-based solvent, an ester-based solvent, an ether-based solvent, a ketone-based solvent, an alcohol-based solvent, an aprotic solvent, or a combination thereof, and may be used alone or in a mixture of two or more types. Further, when the carbonate-based solvent is used, a mixture of a cyclic carbonate and a chain carbonate may be used.

The first electrode current collector plate 300 may have a substantially disk shape and may be electrically connected to a positive electrode terminal 510 (described below). The first electrode current collector plate 300 may be coupled to the positive electrode terminal 510 by welding. Since the first electrode current collector plate 300 is electrically connected to the first electrode plate 210, the first electrode plate 210 and the positive electrode terminal 510 may be electrically connected.

The second electrode current collector plate 400 may have a substantially disk shape, and edges thereof may be bent in a streamlined shape so as to be in contact with the beading portion 122. The second electrode current collector plate 400 may be coupled to the beading portion 122 by welding. Since the second electrode current collector plate 400 is electrically connected to the second electrode plate 220, the second electrode plate 220 and the can 100 may be electrically connected.

The terminal portion 500 may include the positive electrode terminal 510 and at least one gasket 520. The positive electrode terminal 510 is coupled to the upper surface portion 110 of the can 100 and is electrically connected to the first electrode plate 210 through the first electrode current collector plate 300. The positive electrode terminal 510 is coupled to the upper surface portion 110 with a riveting method. The positive electrode terminal 510 may be inserted into the terminal hole from outside of the can 100, and then an inner end portion thereof may be compressed and deformed through processing such as pressing, spinning, or the like to be in close contact with the inside of the upper surface portion 110. Alternatively, the positive electrode terminal 510 may be inserted into the terminal hole in the can 100 and then an outer end portion may be compressed and deformed to bring the outer end portion into close contact with the outside of the upper surface portion 110. In this case, the gasket 520 may be inserted between the positive electrode terminal 510 and the terminal hole and insulate the can 100 and the positive electrode terminal 510.

The gasket 520 is composed of an insulating material and may include a first gasket 522, a second gasket 524, and a third gasket 526. The first gasket 522 insulates between the positive electrode terminal 510 and the upper surface portion 110. Accordingly, a size of the first gasket 522 may be larger than a portion of the positive electrode terminal 510 exposed to outside of the upper surface portion 110. The second gasket 524 insulates between the positive electrode terminal 510 and the terminal hole of the upper surface portion 110. The third gasket 526 insulates between the upper surface portion 110 and the first electrode current collector plate 300. Accordingly, the third gasket 526 may have the same or similar size and shape as the first electrode current collector plate 300. Alternatively, the third gasket 526 may have the same or similar size and shape as the upper surface portion 110. In some embodiments, an insulating tape 530 may be attached to the first electrode current collector plate 300 instead of the third gasket 526. Further, in some embodiments, the first gasket 522, the second gasket 524, and the third gasket 526 may be integrally provided.

The cap assembly 600 may include a cap plate 610 and an insulator 620. An edge of the cap plate 610 is fixed to the side portion 120 of the can 100 by the beading portion 122 and the crimping portion 124 and is insulated from the side portion 120 by the insulator 620. A notch 612 may be formed in the cap plate 610, with the notch being configured to break when an internal pressure exceeds a certain pressure. The notch 612 is formed to be thinner than the other region and serves as a vent through which internal gas is discharged when the notch is broken.

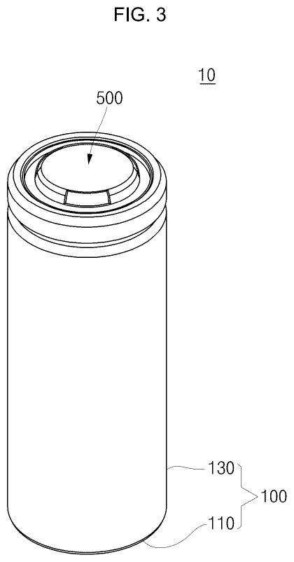

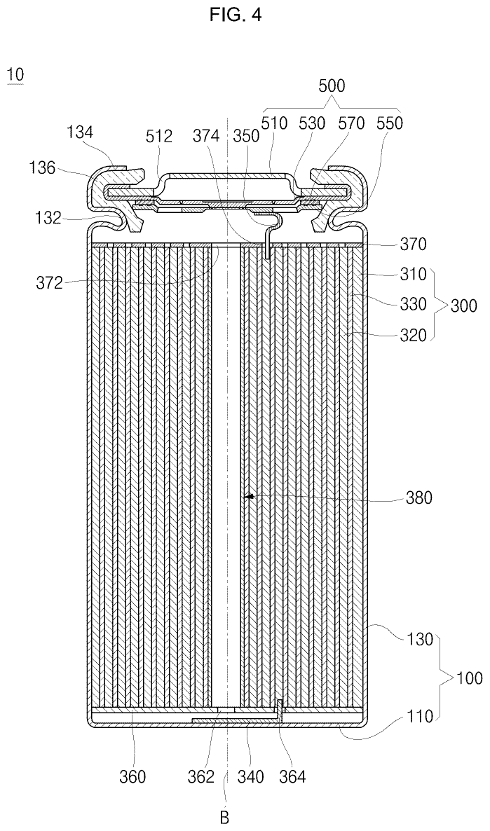

FIG. 3 is a perspective view of an exemplary cylindrical secondary battery. FIG. 4 is a cross-sectional view of the cylindrical secondary battery according to FIG. 3. Detailed description for configurations having the same functions as the above-described secondary battery and the same features will be omitted in the following descriptions.

Referring to FIGS. 3 and 4, an exemplary secondary battery 10 may include a cylindrical can 100, an electrode assembly 300 inserted into the can 100, a cap assembly 500 inserted into one end of the can 100, and an insulating gasket 136 inserted between the can 100 and the cap assembly 500. The electrode assembly 300 may be supported by a center pin 380 (which is optional).

The can 100 includes a circular bottom portion 110 and a side portion 130 extending upward from the bottom portion 110, and an upper portion of the side portion 130 is open (hereinafter, referred to as an opening). The cap assembly 500 is inserted into the opening of the can 100. A beading portion 132 and a crimping portion 134 may be formed on the side portion 130 to fix the cap assembly 500. In a manufacturing process of the secondary battery 10, the electrode assembly 300 may be inserted into the can 100 along with an electrolyte through the opening of the can 100.

The electrode assembly 300 includes a negative electrode plate 310, a positive electrode plate 320, and a separator 330. The negative electrode plate 310 may have a negative electrode active material (for example, graphite, carbon, or the like) formed on both surfaces. The positive electrode plate 320 may have a positive electrode active material (for example, a transition metal oxide (LiCoO₂, LiNiO₂, LiMn₂O₄, or the like)) formed on both surfaces. The separator 330 is disposed between the negative electrode plate 310 and the positive electrode plate 320 to prevent a short circuit and allow only lithium ions to move between the plates 310 and 320. The negative electrode plate 310, the positive electrode plate 320, and the separator 330 may be wound in a substantially cylindrical shape and accommodated in the can 100. The negative electrode plate 310 may be composed of a copper (Cu) or nickel (Ni) foil, the positive electrode plate 320 may be composed of an aluminum (Al) foil, and the separator 330 may be composed of polyethylene (PE) or polypropylene (PP), but the present disclosure is not limited to these materials. A negative electrode tab 340 protruding and extending downward a certain length may be welded to the negative electrode plate 310 and a positive electrode tab 350 protruding upward a certain length may be welded to the positive electrode plate 320, but the reverse is also possible. The negative electrode tab 340 may be composed of a copper or nickel material, and the positive electrode tab 350 may be composed of an aluminum material, but the present disclosure is not limited to these materials. The negative electrode tab 340 may be welded to the bottom portion 110 of the can 100, and, in such a case, the can 100 may function as a negative electrode. On the other hand, the positive electrode tab 350 may be welded to the bottom portion 110 of the can 100, and in such a case, the can 100 may operate as a positive electrode. An example in which the negative electrode tab 340 is welded to the bottom portion 110 of the can 100 is shown in FIG. 4.

Above, a structure in which the negative electrode plate 310 and the positive electrode plate 320 are electrically connected to the can 100 and the cap assembly 500, respectively, through the negative electrode tab 340 and the positive electrode tab 350 was described. However, a negative electrode uncoated portion and a positive electrode uncoated portion not provided with an active material may be respectively configured in the negative electrode plate 310 and the positive electrode plate 320, thereby eliminating the need for the negative electrode tab 340 and the positive electrode tab 350. In such a case, the negative electrode uncoated portion may be directly brought into contact with the bottom portion 110 of the can 100 or welded to a negative electrode current collector plate and then electrically connected to the can 100 through the negative electrode current collector plate. The positive electrode uncoated portion may be welded to a positive electrode current collector plate and electrically connected to the cap assembly using the positive electrode current collector plate as a positive electrode lead.

A first insulating plate 360 and a second insulating plate 370 may be disposed above and below the electrode assembly 300. The first insulating plate 360 prevents the positive electrode plate 320 from being in electrical contact with the bottom portion 110 of the can 100, and the second insulating plate 370 prevents the negative electrode plate 310 from being in electrical contact with the cap assembly 500.

A first hole 362 that communicates with a center pin 380 and a second hole 364 through which the negative electrode tab 340 may pass may be formed through the first insulating plate 360. The first hole 362 allows gas to move upward through the cylindrical center pin 380 when a large amount of gas is generated due to an abnormality in the secondary battery. The negative electrode tab 340 may pass through the second hole 364 and may be welded to the bottom portion 110.

A first hole 372 through which gas may move toward the cap assembly 500 when a large amount of gas is generated due to an abnormality in the secondary battery may be formed through the second insulating plate 370. Further, a second hole 374 through which the positive electrode tab 350 may pass is formed through the second insulating plate 370. The positive electrode tab 350 may be welded to a cap down 550 (described below). A plurality of second holes 374 may be formed and serve as inlets through which an electrolyte is injected into the electrode assembly 300 in an electrolyte injection process.

The cap assembly 500 may include a cap upper part 510 that exposed to outside of the can 100, the cap lower part 550 disposed under the cap upper part 510. A vent plate 530 may be disposed between the cap upper plate 510 and the cap lower part 550, and an insulator 570 may be disposed between the vent plate 530 and the cap lower part 550.

The cap upper part 510 is disposed at the uppermost portion of the cap assembly 500 and may include a piercing hole 512 that allows gas generated inside the can 100 to be discharged to outside of the battery 10. The cap upper part 510 may have a roughly disk shape, and a certain region thereof may protrude upward and be centered on a central axis B. The vent plate 530 may be disposed under the cap up 510.

The vent plate 530 has a roughly disk shape, and an edge thereof is bent toward an edge of the cap upper part 510 to be in contact with a lower portion of the edge of the cap upper part 510. The vent plate 530 may be bent again toward the inside of the can 100 from the portion in contact with the cap upper part 510 to be in contact with an upper portion of the edge of the cap upper part 510. At least one notch may be formed in the vent plate 530. When a gas pressure in the can 100 is greater than a predetermined breaking pressure, the notch may be broken as the vent plate 530 is flipped upward. Accordingly, gas in the can 100 may be quickly discharged through the piercing hole 512 of the cap upper part 510 to outside of the battery 10.

The cap lower part 550 is disposed under the vent plate 530 and has a roughly disk shape. For example, the cap lower part 550 may be formed of aluminum, an aluminum alloy, and equivalents thereof, but the materials are not limited thereto. The cap lower 550 supports the cap upper part 510 to prevent the cap upper part 510 from being deformed by an external force. An edge of the cap lower part 550 is bent toward the vent plate 530, and the insulator 570 is disposed on the bent portion of the cap lower part 550. A central portion of the cap lower part 550 is in contact with the vent plate 530. A contact region between the cap lower part 550 and the vent plate 530 may be connected by welding. Since the cap lower part 550 is welded to the positive electrode tab 350, the cap lower part 550, the vent plate 530, and the cap upper part 510 may all have a positive polarity.

The insulator 570 is a roughly ring-shaped insulator and serves to insulate the vent plate 530 and the cap lower part 550 from each other. The insulator 570 may be formed, for example, of polyethylene (PE), polypropylene (PP), polystyrene (PS), an ethylene-vinyl acetate copolymer (EVA), or an equivalent thereof, but is not limited thereto. The insulator 570 may be coupled to the vent plate 530 and cap lower part 550 through a method such as ultrasonic welding, laser welding, fusion, or the like.

In the electrode assembly described in the above embodiments, the first electrode plate (or the positive electrode plate) and the second electrode plate (or the negative electrode plate) are wound along with the separator. In such a configuration, a first uncoated portion (or the positive electrode uncoated portion) and a second uncoated portion (or the negative electrode uncoated portion) are disposed opposite to each other during winding. Hereinafter, a secondary battery manufacturing device, a secondary battery manufacturing method, and a manufacturing device will be described.

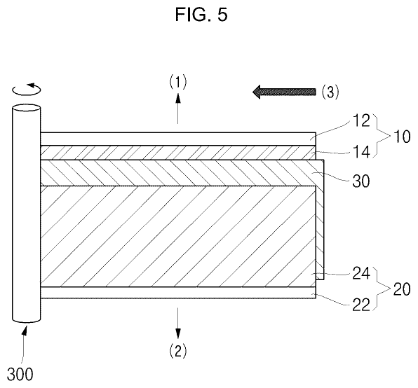

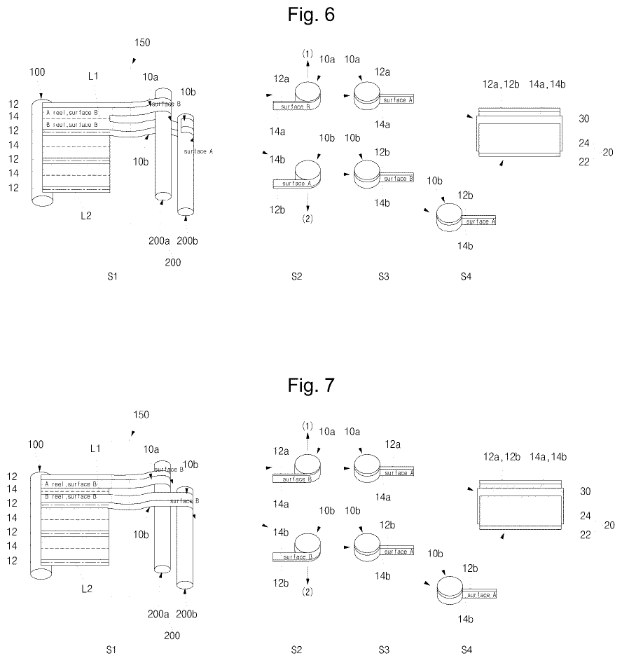

FIG. 5 is a schematic diagram illustrating a supply state of winding material during winding of an exemplary electrode assembly. FIG. 6 is a schematic diagram illustrating a part of the winding process of the electrode assembly according to one embodiment. FIG. 7 is a schematic diagram illustrating a part of the winding process of the electrode assembly according to another embodiment.

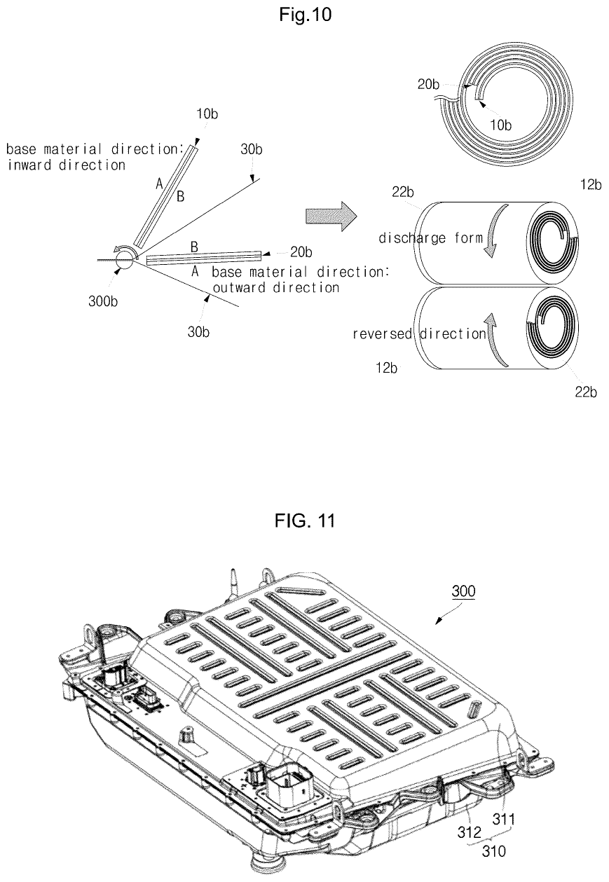

Referring to FIG. 5, when a negative electrode plate 10, a positive electrode plate 20, and a separator 30 are wound, a direction in which each winding material is unwound from a reel on which the winding material is wound and supplied to a winder 300 is a direction indicated by arrow (3). In this case, the winding materials may be supplied so that a negative electrode uncoated portion 12 of the negative electrode plate 10 may face a direction indicated by arrow (1) and a positive electrode uncoated portion 22 of the positive electrode plate 20 may face a direction indicated by arrow (2). The separator 30 is disposed between the negative electrode plate 10 and the positive electrode plate 20. Although omitted in FIG. 5 to show disposition of the uncoated portions, the separator 30 is disposed on both the front and back of the positive electrode plate 20 (see FIGS. 9 and 10).

Generally, when the active material is coated on an electrode plate during the manufacturing process of a secondary battery, coating is continuously performed. However, the active material may be coated in a specific pattern or stripe shape depending on a structure of the secondary battery. For example, as shown in FIGS. 6 and 7, a plurality of active material layers 14 may be coated on one electrode plate foil in a striped pattern along a discharge direction of the electrode plate foil. A plurality of uncoated portions 12 may be provided at both edges and a center along the discharge direction of the electrode plate foil. When the active material is manufactured in a striped coating form, the coating may be unbalanced with respect to the movement of lithium ions and the N/P ratio per number of turns (the number of turns the electrode assembly is wound, defined as one turn when wound one turn). Unbalanced coating is a coating method of applying different coating thicknesses to a surface A (one of two surfaces) and a surface B (the other of the two surfaces) of the electrode plate foil. Unbalanced coating may be applied to any one or both of the negative electrode plate and the positive electrode plate. When unbalanced coating is formed, it is the surface A and the surface B of the electrode plate foil may need to be distinguished when the electrode assembly is wound. Further, since the uncoated portions of the negative electrode plate and the positive electrode plate may be disposed opposite to each other, the disposition directions of the uncoated portions may need to be distinguished when the electrode assembly is wound.

When the coating of the active material is completed, a process of cutting the electrode plate to meet specifications of the secondary battery (a slitting process, operation S1 in FIGS. 6 and 7) may be performed. The cutting is performed in a region coated with the active material (a dotted line L1) and an uncoated portion region (a dotted line L2). Processes of cutting and winding the electrode plate will be described in more detail below. For convenience, although FIGS. 6 and 7 are illustrated based on the winding material (the electrode plate foil) for the negative electrode plate, in practice two unwinders are provided to supply the negative electrode plate foil and the positive electrode plate foil to slitters, respectively.

Referring to FIG. 6, a negative electrode foil (a winding material) provided with a plurality of negative electrode uncoated portions 12 and negative electrode active material portions 14 in a striped form is wound around an unwinder 100. Cutting is performed along a center of the negative electrode uncoated portion 12 and a center of the negative electrode active material portion 14 by a cutter (not shown) while the winding material is unwound from the unwinder 100. The cut negative electrode foils are respectively wound around a rewinder 200. A bobbin (not shown) is provided in the rewinder 200, and the winding material wound around the bobbin is referred to as a reel. The reels may be respectively referred to as an A reel and a B reel in that order. The A reel and the B reel may be arbitrary names, but reels having the same uncoated portion direction or the same plate surface direction of the winding material may be grouped and classified as the A reel, the B reel, and the like.

As described in FIG. 5, when the negative electrode plate 10 is wound around the winder 300, the negative electrode uncoated portion 12 should be disposed in the direction of arrow (1). Accordingly, in the slitting process S1, a direction in which the negative electrode plate 10 discharged from the unwinder 100 is wound around the rewinder 200 may be determined in consideration of a direction of the negative electrode uncoated portion 12 of each reel. Although only two rewinders 200a and 200b are shown in the drawings, for convenience of description, three or more rewinders 200 may be provided. Further, although a case in which only one A reel 10a and one B reel 10b are respectively wound around the rewinders 200a and 200b is shown, a plurality of A reels 10a and a plurality of B reels 10b may be simultaneously wound.

Referring to FIG. 6, in order to adjust the direction of the negative electrode uncoated portion 12, the A reel 10a may be wound around the rewinder 200a so that a surface B may face outward, and the B reel 10b may be wound around the rewinder 200b so that a surface A may face outward. After the slitting process, the direction of the negative electrode uncoated portion 12 of the A reel 10a faces the direction of the arrow (1) (S1). Accordingly, the reel 10a may be unwound (S3) as it is and supplied to the winder 300. In this case, the A reel is unwound with the surface B facing outward and the surface A facing inward. However, after the slitting process, the direction of the negative electrode uncoated portion 12 of the B reel 10b faces the direction of the arrow (2) (S2). Accordingly, the B reel 10b should be reversed to adjust the direction of the negative electrode uncoated portion 12 to be supplied to the winder 300 (S3). When the reel is reversed, the B reel 10b is unwound with the surface A facing outward and the surface B facing inward. In this case, it is not possible to make an electrode assembly as the surfaces A and B of the negative electrode plate for each reel face different directions. Accordingly, the B reel 10b needs to be unwound again and rewound so that the surface B faces outward like the A reel 10a (S4). That is, there is a problem in that a process of unwinding again and rewinding the negative electrode plate discharged during the slitting process and wound around the rewinder 200 must also be adjusted to the direction of the negative electrode uncoated portion 12 in the winder 300 (S4). The same problem may occur when manufacturing the positive electrode plate.

On the other hand, in the slitting process S1, the direction in which the negative electrode plate 10 discharged from the unwinder 100 is wound around the rewinder 200 may be determined in consideration of which surface of each reel faces outward.

Referring to FIG. 7, in order to adjust the disposition of the surface A or surface B of the negative electrode plate 10, both the A reel 10a and the B reel 10b may be wound around the rewinders 200a and 200b so that the surfaces B may face outward. After the slitting process, the surfaces B of both the A reel 10a and the B reel 10b face outward, but the direction of the negative electrode uncoated portion 12 is reversed. The A reel 10a may be unwound (S2) as it is supplied to the winder 300 (S3) as the direction of the negative electrode uncoated portion 12 faces the direction of the arrow (1). In this case, the A reel is unwound with the surface B facing outward and the surface A facing inward. However, after the slitting process, the direction of the negative electrode uncoated portion 12 of the B reel 10b faces the direction of the arrow (2). When the B reel 10b is unwound as is, the surface B faces outward but the negative electrode uncoated portion 12 still faces the direction of the arrow (2). Accordingly, the B reel 10b should be unwound again and rewound to adjust the direction of the negative electrode uncoated portion 12 to be supplied to the winder 300 so that the direction of the negative electrode uncoated portion 12 faces the direction of the arrow (1) like the A reel 10a. That is, there is a problem in that a process of unwinding again and rewinding the negative electrode plate discharged during the slitting process and wound around the rewinder 200 must be adjusted with respect to the directions of the surface A and the surface B in the winder 300. The same problem may occur when manufacturing the positive electrode plate.

Accordingly, in an embodiment of the present disclosure, there is provided a dual winding device that allows reels with different directions of the uncoated portions or plate surfaces to be directly wound to prevent the winding material (the negative electrode foil or positive electrode foil) from being unwound again and rewound.

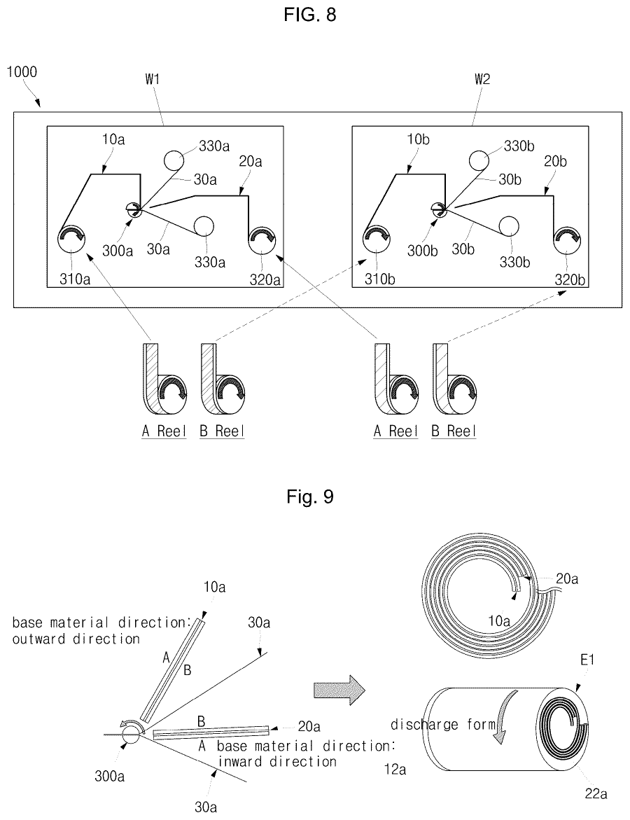

FIG. 8 is a schematic diagram illustrating a secondary battery manufacturing device according to the present disclosure. FIG. 9 is a schematic diagram briefly illustrating an electrode assembly wound by a first winding device according to FIG. 8. FIG. 10 is a schematic diagram briefly illustrating an electrode assembly wound by a second winding device according to FIG. 8. For convenience, the wound negative electrode foil and positive electrode foil are referred to as the negative electrode plate and the positive electrode plate.

Referring to FIG. 8, a secondary battery manufacturing device 1000 according to one embodiment of the present disclosure may include a first winding device W1 which winds only the A reels of both the negative electrode plate 10 and the positive electrode plate 20, and a second winding device W2 which winds only the B reels of both the negative electrode plate 10 and the positive electrode plate 20. The secondary battery manufacturing device 1000 may include the unwinder 100, a cutter (not shown), and the rewinder 200 for the above-described slitting process. The unwinder 100, the cutter (not shown), and the rewinder 200 are described above, accordingly the description is not repeated. The first winding device W1 may include a first winder 300a for final winding, a first reel support 310a which supplies an A reel negative electrode plate 10a, a second reel support 320a which supplies an A reel positive electrode plate 20a, and a pair of separator supports 330a which supply separators 30a. The second winding device W2 may also include a second winder 300b for final winding, a third reel support 310b which supplies a B reel negative electrode plate 10b, a fourth reel support 320b which supplies a B reel positive electrode plate 20b, and a pair of separator supports 330b which supply separators 30b. Here, the A reel negative electrode plate 10a and the B reel positive electrode plate 20a may mean a reel wound so that a negative electrode uncoated portion 12a faces the direction of the arrow (1) and a positive electrode uncoated portion 22a faces the direction of the arrow (2), respectively, as shown in FIG. 5. The A reel may be a reel wound so that one surface of the surface A and the surface B faces outward. Further, the B reel may be a reel wound so that a negative electrode uncoated portion 12b faces the direction of the arrow (2) and a positive electrode uncoated portion 22b faces the direction of the arrow (1) (opposite to FIG. 5). The B reel may be a reel wound so that a surface the same as that of the A reel faces outward.

A process of winding the electrode assembly in the first winding device W1 will be described first.

As shown in FIG. 8, the A reel negative electrode plate 10a and the A reel positive electrode plate 20a are supplied to the first winder 300a along with the separators 30a. Two separators 30a are supplied to be respectively disposed on the surface A and the surface B of the positive electrode plate 20a. A winding direction and disposition of the negative electrode plate 10a and the positive electrode plate 20a in the first winder 300a are enlarged in FIG. 9. When the first winder 300a is wound in a counterclockwise direction, the negative electrode plate 10a is disposed outside the separators 30a and the positive electrode plate 20a is disposed between the two separators 30a. In this case, a base material direction of the positive electrode plate 20a becomes an inward direction and a base material direction of the negative electrode plate 10a becomes an outward direction. When the negative electrode plate 10a, the separators 30a, and the positive electrode plate 20a are wound in this state, an electrode assembly El wound in a counterclockwise direction as shown in an upper right end in FIG. 9 is discharged. In this case, as shown in a lower right end in FIG. 9, the negative electrode uncoated portion 12a of the electrode assembly E1 may face the left side and the positive electrode uncoated portion 22a may face the right side.

On the other hand, referring to FIGS. 8 and 10, the direction of the uncoated portion of the B reel is opposite to that of the A reel. Accordingly, in the second winding device W2, a base material direction of the negative electrode plate 10b becomes an inward direction and a base material direction of the positive electrode plate 20b becomes an outward direction when the second winder 300b is wound in a counterclockwise direction. As described herein, inward direction means a direction toward a winding center and the outward direction means a direction toward the outside of the electrode assembly. When the negative electrode plate 10b, the separators 30b, and the positive electrode plate 20b are wound in this state, an electrode assembly E2 is wound in a clockwise direction as shown in the discharge form on the right side in FIG. 10. In this case, the discharge form of the electrode assembly E2 is the same as an upper portion of the lower right end in FIG. 10 according to the direction of the uncoated portion of the B reel. That is, the negative electrode uncoated portion 12b faces the right direction, and the positive electrode uncoated portion 22b faces the left direction. When the electrode assembly E2 in FIG. 10 is rotated in the same direction as the electrode assembly E1 in FIG. 9, a winding direction the same as a lower portion of the lower right end in FIG. 10 is shown. That is, the B reel electrode assembly E2 in FIG. 10 has a winding direction opposite to that of the A reel electrode assembly E1 in FIG. 9.

Accordingly, when secondary batteries are manufactured by manufacturing each of the A reel electrode assembly E1 and the B reel electrode assembly E2, secondary batteries having opposite electrode assembly winding directions are manufactured. The secondary battery made of the A reel electrode assembly E1 may be referred to as a first secondary battery, and the secondary battery made of the B reel electrode assembly E2 may be referred to as a second secondary battery. According to the above description, the winding directions of the electrode assemblies of the first secondary battery and the second secondary battery are opposite to each other. When these secondary batteries are used to configure a battery module or battery pack, a plurality of first and second secondary batteries having opposite electrode assembly winding directions are mixed. The winding direction of the electrode assembly is not related to the capacity or performance of the secondary battery. Accordingly, a process of unwinding again and rewinding a previously wound winding material to adjust the direction of the uncoated portion or electrode plate surface is not necessary. Further, since the electrode assembly may be produced by winding without rewinding a reel with a different direction of the uncoated portion or electrode plate surface, the manufacturing time and manufacturing process may be reduced.

The secondary battery according to the above-described embodiment may be used to manufacture a battery pack.

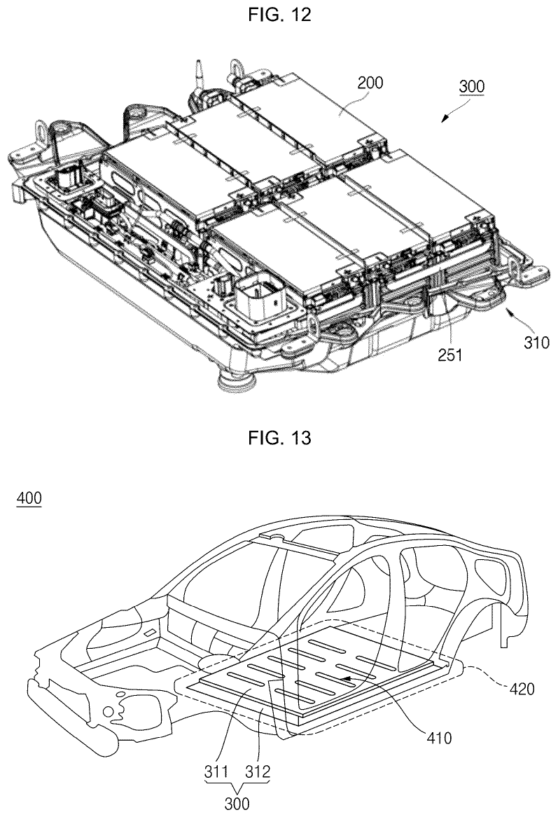

FIGS. 11 and 12 are perspective views illustrating a battery pack 300 including an exemplary cylindrical secondary battery according to the present disclosure. Referring to FIGS. 11 and 12, the battery pack 300 may include a plurality of battery modules 200 and a housing 310 for accommodating the plurality of battery modules 200. The housing 310 may include first and second housings 311 and 312 coupled in directions facing each other with the plurality of battery modules 200 interposed therebetween. The plurality of battery modules 210 may be electrically connected to each other using bus bars 251, and the plurality of battery modules 200 may be electrically connected to each other in series/parallel or a series-parallel mixed method to acquire the required electrical output. In the drawings, for convenience of illustration, components such as bus bars for electrical connection of battery cells, cooling units, external terminals, and the like are omitted. In some examples, the battery pack 300 may be mounted in a vehicle. The vehicle may be, for example, an electric vehicle, a hybrid vehicle, or a plug-in hybrid vehicle. The vehicle may include a four-wheeled vehicle or two-wheeled vehicle.

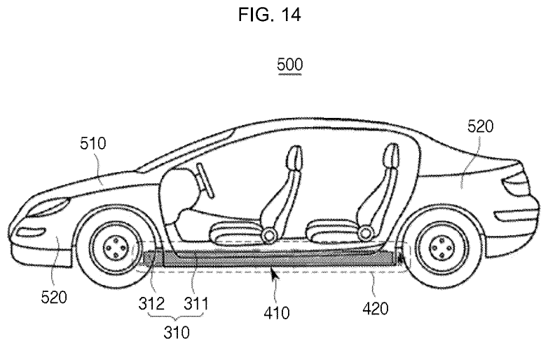

FIGS. 13 and 14 are a perspective view and a side view illustrating vehicles 400 and 500 including the exemplary battery pack 300 according to the present disclosure, respectively. In FIG. 13, the battery pack 300 may include a battery pack cover 311 (which may correspond to the first housing), which is a part of a vehicle underbody 410, and a pack frame 312 (which may correspond to the second housing) disposed under the vehicle underbody 410. The battery pack cover 311 and the pack frame 312 may have a structure integrally formed with a vehicle floor 420. The vehicle underbody 410 separates the interior and exterior of a vehicle, and the pack frame 312 may be disposed on the exterior of the vehicle.

As shown in FIG. 14, the vehicle 500 may be formed by combining a vehicle body 400 with additional components such as a hood 510 located at the front of the vehicle and fenders 520 located at the front and rear of the vehicle. The vehicle 500 may include the battery pack 300 including the battery pack cover 311 and the pack frame 312, and the battery pack 300 may be coupled to the vehicle body part 400.

According to the embodiment of the present disclosure, a process of unwinding again and rewinding a previously wound winding material to adjust a direction of an uncoated portion or electrode plate surface is not necessary. Further, since an electrode assembly can be produced by winding a reel with a different direction of an uncoated portion or electrode plate surface as is without rewinding the reel, the manufacturing time and manufacturing process can be reduced.

However, effects which can be acquired through the present disclosure are not limited to the above-described effects, and other technical effects that are not mentioned will be clearly understood by those skilled in the art from the description above.

What has been described above are only some embodiments for implementing the present disclosure, and the present disclosure is not limited to the above-described embodiments. The technical spirit of the present disclosure extends to the extent that various modifications may be made by anyone skilled in the art without departing from the gist of the present disclosure.

What is claimed is:

1. A secondary battery manufacturing device comprising:
an unwinder configured to supply a wound electrode plate foil;
a plurality of slitters configured to cut the electrode plate foil supplied from the unwinder at predetermined intervals to form a plurality of electrode plate foils;
a plurality of rewinders configured to wind the electrode plate foils discharged from the slitters in one direction; and
a first winding device and a second winding device configured to wind the electrode plate foils discharged from the rewinders and separators and to discharge wound electrode assemblies that include the electrode pate foils and separators.

2. The secondary battery manufacturing device of claim 1, wherein the electrode plate foils include portions coated with an active material and uncoated portions that are not coated with an active material, and
Wherein the uncoated portions of reels of the wound electrode plate foils discharged from the rewinders face different directions.

3. The secondary battery manufacturing device of claim 2, wherein the reels of the wound electrode plate foils discharged from the rewinders have a same type of surface facing towards outside of the winding.

4. The secondary battery manufacturing device of claim 3, wherein the unwinder is provided as two unwinders, with a first of the unwinders being configured to supply a negative electrode plate foil and a second of the unwinders being configured to supply a positive electrode plate foil.

5. The secondary battery manufacturing device of claim 4, wherein the first winding device is configured to wind the electrode assembly such that a negative electrode uncoated portion and a positive electrode uncoated portion face different directions.

6. The secondary battery manufacturing device of claim 5, wherein the second winding device is configured to wind the electrode assembly such that a negative electrode uncoated portion and a positive electrode uncoated portion face directions opposite to the directions that the negative electrode uncoated portion and the positive electrode uncoated portion face in the electrode assembly wound by the first winding device.

7. The secondary battery manufacturing device of claim 6, wherein the first winding device and the second winding device are configured to wind electrode assemblies in opposite directions.

8. The secondary battery manufacturing device of claim 4, wherein the negative electrode plate foil and the positive electrode plate foil are coated with an active materials in a stripe pattern along a longitudinal direction.

9. The secondary battery manufacturing device of claim 8, wherein the negative electrode plate foil, the positive electrode plate foil, or both the negative electrode plate foil and the positive electrode plate foil are coated with the active materials on one surface or both surfaces thereof in an unbalanced manner.

10. A battery module comprising a plurality of secondary batteries manufactured by the secondary battery manufacturing device according to claim 1.

11. The battery module of claim 10, wherein the secondary batteries include a plurality of first secondary batteries and second secondary batteries having electrode assemblies that are wound in opposite directions.

12. The battery module of claim 11, wherein each of the electrode assemblies includes a negative electrode plate and a positive electrode plate.

13. The battery module of claim 12, wherein each of the negative electrode plates and the positive electrode plates are coated with an active material in a stripe pattern along a longitudinal direction.

14. The battery module of claim 13, wherein the negative electrode plate, the positive electrode plate, or both the negative electrode plate and the positive electrode plate are coated with an active material on one surface or both surfaces thereof in an unbalanced manner.
